(19) United States
(12) Patent Application Publication
(10) Pub. No.: US 2016/0087555 A1
(43) Pub. Date: Mar. 24, 2016

(54) RCP SYSTEM FOR CONTROLLING POWER SUPPLY APPARATUS

(71) Applicant: FUJITSU LIMITED, Kawasaki-shi (JP)

(72) Inventors: Hisato HOSOYAMA, Yokohama (JP); Yu Yonezawa, Sagamihara (JP); Tomotake Sasaki, Kawasaki (JP)

(73) Assignee: FUJITSU LIMITED, Kawasaki (JP)

(21) Appl. No.: 14/837,129

(22) Filed: Aug. 27, 2015

(30) Foreign Application Priority Data
Sep. 22, 2014 (JP) 2014-192688

(51) Int. Cl. H02N 2/18; G05B 19/042

(52) U.S. Cl. CPC H02N 2/181; G05B 19/042; G05B 2219/25254

(57) ABSTRACT

An RCP (Rapid Control Prototyping) system for controlling a power supply apparatus, the RCP system includes: a computer; an MPU; and a bridge configured to connect the computer and the MPU and transfer data between the computer and the MPU using DMA, wherein the MPU is configured to generate an AD value from a signal of the power supply apparatus according to a switching period of the power supply apparatus, instruct to transfer the generated AD value to the computer using DMA via the bridge, and control the power supply apparatus according to a compensation value transferred using DMA via the bridge, and the computer is configured to instruct to transfer the compensation value calculated based on the AD value transferred through the last DMA to the MPU using DMA via the bridge and calculate the compensation value based on the AD value newly transferred using DMA.

### CROSS-REFERENCE TO RELATED APPLICATION

This application is based upon and claims the benefit of priority of the prior Japanese Patent Application No. 2014-192688, filed on Sep. 22, 2014, the entire contents of which are incorporated herein by reference.

### FIELD

The embodiments discussed herein are related to an RCP (Rapid Control Prototyping) system for controlling a power supply apparatus.

### BACKGROUND

As a development method of a control program of an ECU (Electronic Control Unit) installed on a vehicle, a method is known in which a source code of the control program is automatically generated on a computer for development equipped with a simulator program. The automatic generation method is known as a MBD (Model Based Development) which prepares a control model (which is a graphical representation of a control logic using, for example, a block diagram) and verifies an appropriateness of the control model (e.g., a control logic) with respect to a control specification. Also, the MBD automatically generates the source code of the control program from the verified control model. The MBD is used to make it possible to efficiently develop the control program of the ECU such that a development time is shortened and a development cost is reduced.

In the MBD, it is confirmed whether the control logic is correctly designed before the automatic code is generated. Therefore, the RCP (Rapid Control Prototyping) is performed that confirms an operation of a prototype engine for mass production and verifies the correctness of the control model by replacing the control logic with a high performance computer rather than an MPU (Microprocessor Unit) for mass production.

The RCP is a system that faithfully reproduces the control model confirmed by a computer simulation in the high performance computer as it is (seamlessly) to verify a prototype control target. The RCP may be used so as to verify the control model without preparing a program.

Although the RCP has been applied only to a vehicle related field but not applied to other technical fields, it may be considered that the RCP may also be applied to other technical fields to achieve an efficiency of development. However, when the RCP is applied to other technical fields, there may be a case where the RCP method used in the vehicle related field may not be applied to the other technical fields depending on the type of the technical fields. For example, in a case where the RCP applied to the vehicle related field is applied to a digital power supply (e.g., digitally controlling a switching power supply), a control period of the digital power supply is shorter compared to that of the vehicle related field. Therefore, it has been difficult to apply a configuration employed in the RCP of the vehicle related field to the RCP of the power supply related field.

The high performance computer for RCP may employ a general-purpose PC architecture in order to realize a seamless environment at a low cost. The PC architecture allows a large amount of data to be communicated with an external device, but is inappropriate for a real-time communication and has a limit to achieve a high speed system while maintaining an accurate control period required for an RCP environment of the power supply related field.

Therefore, in a case where the configuration employed in the RCP of the vehicle related field is applied to the RCP of the power supply related field, a control is delayed and various problems occur caused by the control delay such as, for example, a problem of destroying a prototype power supply apparatus.

The following are reference documents.

### [Document 1] Japanese Laid-Open Patent Publication No. 11-134286,

### [Document 2] Japanese Laid-Open Patent Publication No. 2004-287654, and

### [Document 3] Japanese National Publication of International Patent Application No. 2009-510994.

### SUMMARY

According to an aspect of the invention, an RCP (Rapid Control Prototyping) system for controlling a power supply apparatus, the RCP system includes: a computer; an MPU; and a bridge configured to connect the computer and the MPU and transfer data between the computer and the MPU using DMA, wherein the MPU is configured to generate an AD value from a signal of the power supply apparatus according to a switching period of the power supply apparatus, instruct to transfer the generated AD value to the computer using DMA via the bridge, and control the power supply apparatus according to a compensation value transferred using DMA via the bridge, and the computer is configured to instruct to transfer the compensation value calculated based on the AD value transferred through the last DMA to the MPU using DMA via the bridge and calculate the compensation value based on the AD value newly transferred using DMA, after detecting by polling that the AD value has been transferred from the MPU via the bridge using DMA.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of an RCP system in which a prototype engine is assumed as a control target;

FIG. 2A and FIG. 2B are diagrams each illustrating a configuration and operations assumed in a case of realizing an RCP system for power supply apparatus, specifically, FIG. 2A is a configurational block diagram and FIG. 2B is a flowchart of operations;

FIG. 3A and FIG. 3B are diagrams each illustrating a configuration of the RCP system for power supply of the embodiment, specifically, FIG. 3A illustrates the entire configuration of the RCP system for power supply and FIG. 3B illustrates a partial configuration of a RCP machine including a high performance computer, a bridge, and an MPU;

FIG. 4 is a flowchart illustrating the operations of the high performance computer and the MPU in the RCP system for power supply of the embodiment, specifically, the left part and right part of FIG. 4 illustrate the operations of the high performance computer and the operations of the MPU, respectively;

FIG. 5 is a diagram illustrating data transferred using DMA (Direct Memory Access) in the RCP system for power supply of the embodiment;

FIG. 6A and FIG. 6B are diagrams for explaining a transfer of an AD value by polling of a counter which polls a count value, specifically, FIG. 6A and FIG. 6B illustrate a time chart and a data configuration in data to be transferred, respectively;

FIG. 7 is a flowchart illustrating the operations of the high performance computer, a bridge, and the MPU in the RCP system for power supply of the embodiment, specifically, the left part, the central part, and the right part of FIG. 7 illustrate the operations of the high performance computer, bridge, and the MPU, respectively;

FIG. 8 is a time chart illustrating a detection of an overrun in which the calculation of a compensation value (PWM) data is not finished until the transfer of the AD value at a next switching period is completed, in the high performance computer; and

FIG. 9 is a diagram illustrating a comparison of a case where the transfer of the AD value is detected by polling with a case where the transfer of the AD value is performed by an interrupt processing, specifically, the upper part of FIG. 9 illustrates the case where the transfer of the AD value is performed by an interrupt processing and the lower part of FIG. 9 illustrates the case where the transfer of the AD value is detected by polling.

### DESCRIPTION OF EMBODIMENTS

Descriptions will be made on an RCP system of a vehicle related field before describing an embodiment.

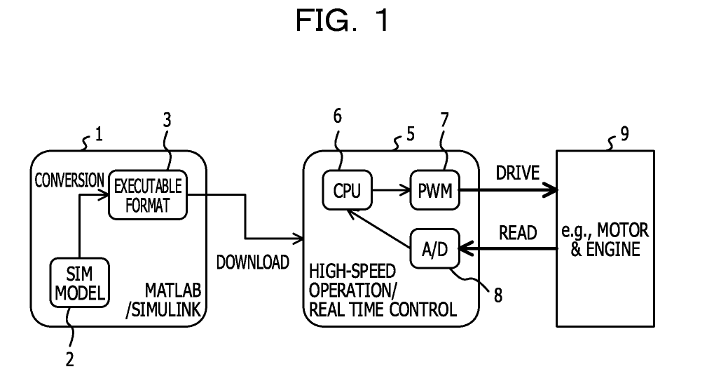

FIG. 1 is a diagram illustrating an exemplary configuration of an RCP system in which a prototype engine is assumed as a control target. The RCP system includes a PC 1, a high performance computer 5 functioning as an RCP machine, and a control target 9 such as a motor and an engine.

Here, the high performance computer 5 functions as the RCP machine. The high performance computer 5 includes a CPU 6, a PWM (Pulse Width Modulation) processing unit 7 which generates a drive signal to be output to the control target 9 such as a motor and an engine, and an A/D converter 8 which reads a sensor signal of the control target 9 to convert the sensor signal into a digital data.

In the PC 1, a simulation model 2 is prepared and converted into an executable format data by, for example, MATLAB (registered trademark)/Simulink. The PC 1 downloads the converted simulation data to the high performance computer 5 and the high performance computer 5 operates the control target based on the downloaded simulation data. The high performance computer 5 for the RCP employs a general purpose PC architecture in order to realize a seamless environment for a simulation model.

Although the PC architecture is able to communicate a large amount of data with an external device and is inappropriate for a real-time communication, a control period of a current vehicle related control target is several milliseconds (ms) and there is no problem in particular in constructing the RCP machine in the vehicle related control target. However, the PC architecture is not suitable for the real-time communication and has a limit to achieve a high speed system so as to maintain an accurate period of time required for an RCP environment for the control target having a short control period which amounts to a range from a single digit or double digits.

The RCP has been applied only to a vehicle related field but not other technical fields. However, it may be considered that the RCP may also be applied to other technical fields to achieve an efficiency of development. However, in a case where the RCP of the vehicle related field is applied to a power supply apparatus having a short switching period, the PC architecture has a limit to achieve a high speed system and the configuration of the RCP of the vehicle related field may not be applied to the RCP of the power supply related field.

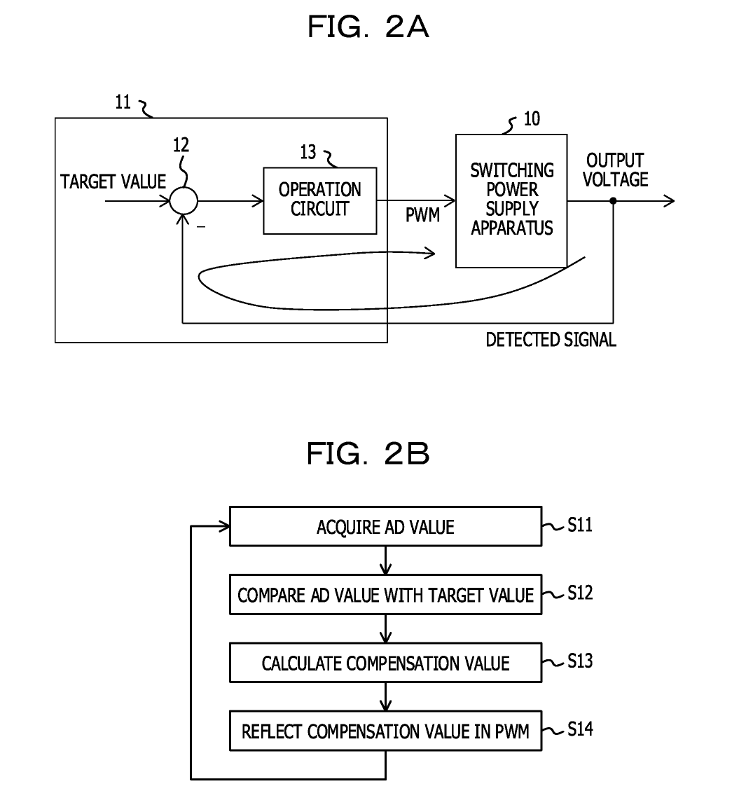

FIG. 2A and FIG. 2B are diagrams each illustrating a configuration and operations assumed in a case of realizing an RCP system for power supply apparatus, specifically, FIG. 2A is a configurational block diagram and FIG. 2B is a flowchart of operations

As illustrated in FIG. 2A, a high performance computer 11 functioning as an RCP machine applies a PWM signal which is a drive signal to a switching (digital) power supply apparatus 10 corresponding to the control target and detects, for example, the voltage and current of each component of the switching power supply apparatus 10. The high performance computer 11 performs an analog-to-digital (AD) conversion on the detected signal to generate an AD value, calculates a difference between a target value and the AD value by a difference calculator 12, generates a PWM signal from a compensation value data according to the difference by the operation circuit 13, and outputs the PWM signal to the switching power supply apparatus 10.

The high performance computer 11 performs step S11 to step S14 illustrated in FIG. 2B in synchronization with a switching period of the switching power supply apparatus 10. At step S11, the detected voltage and current signals of each component of the switching power supply apparatus 10 are subjected to the AD conversion to acquire an AD value.

At step S12, the target value is compared with the AD value to calculate a difference between the target value and the AD value. At step S13, a compensation value data corresponding to the difference is calculated. At step S14, a PWM signal corresponding to the compensation value data is generated.

A phase delay in controlling the switching power supply apparatus 10 is not accumulated over a period, and is required to be always constant.

For example, the switching period of the power supply apparatus is 10 μs or less, and steps S11, S12, S13, and S14 of FIG. 2B are required to be performed within 10 μs or less. However, since the high performance computer employing the PC architecture has a limit to achieve a high speed system, it is difficult for the high performance computer to perform generating the PWM signal, outputting the PWM signal to the power supply apparatus, and generating an AD value obtained by performing the AD conversion on the signal from the power supply apparatus within the switching period (e.g., 10 μs or less) of the power supply apparatus. Therefore, it is difficult to faithfully reproduce a design of model of the power supply apparatus, and a case where the prototype power supply apparatus is destroyed may occur in a worst case.

The RCP system for power supply of the embodiment described in the following makes it possible to perform a control in compliance with the switching period of the power supply apparatus after realizing a seamless environment for a simulation model.

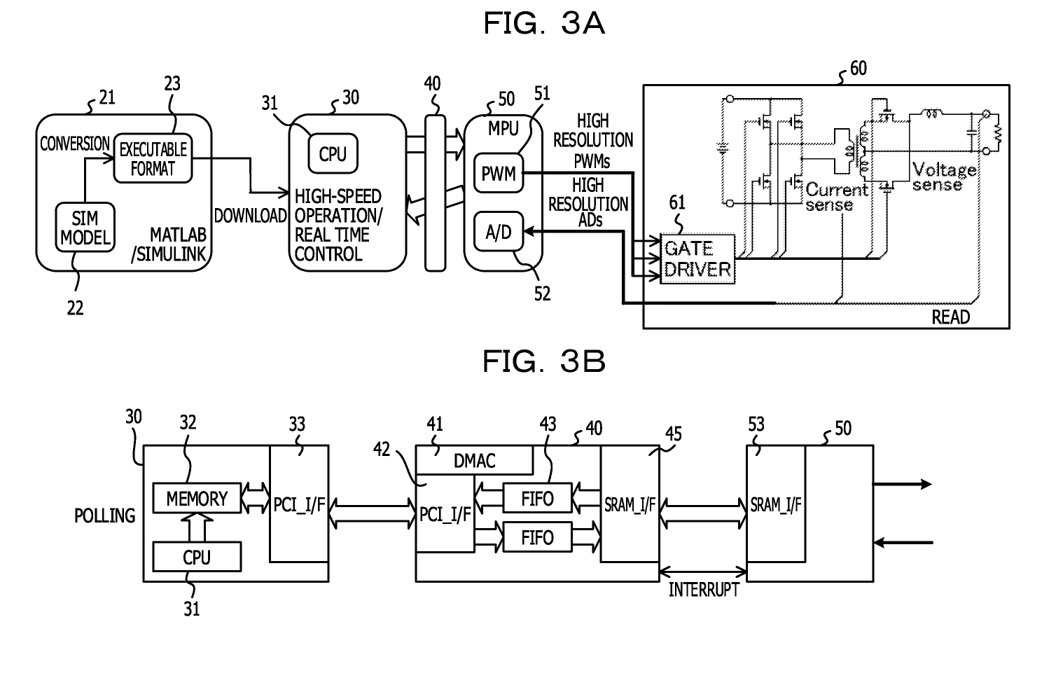

FIG. 3A and FIG. 3B are diagrams each illustrating a configuration of the RCP system for power supply of the embodiment, specifically, FIG. 3A illustrates the entire configuration and FIG. 3B illustrates a partial configuration of an RCP machine including a high performance computer, a bridge, and an MPU

As illustrated in FIG. 3A, the RCP system for power supply of the embodiment includes a PC 21, an RCP machine including a high performance computer, a bridge and an MPU, and a switching (digital) power supply 60 which is a control target.

Here, the high performance computer 30, the bridge 40 and the MPU 50 constitute the RCP machine. The PC 21 uses MATLAB (registered trademark)/Simulink to prepare a simulation model 22 and convert the simulation model 22 into an executable format data, and downloads the converted simulation data to the high performance computer 30. The switching power supply 60 is controlled by the PWM signal generated from high resolution data from the MPU 50 and outputs the voltage and current of each component to the MPU 50 as detected signals. Recently, the switching power supply 60 is required to perform an accurate control at a high speed depending on a load in order to achieve power saving, and controlled by the PWM signal generated from the high resolution data in a short period.

As described above, the switching period of the switching power supply 60 is 10 μs or less, and the RCP machine is required to perform step S11 to step S14 of FIG. 2B during the switching period. The PC architecture has a limit to achieve a high speed system and is insufficient for a high speed AD conversion function or a peripheral function such as an input/output function. Therefore, in the embodiment, a built-in type MPU 50 having sufficient peripheral functions is easily available with low cost and is used as an alternate interface (I/F), and a bridge 40 performing a high speed I/F conversion is provided between the high performance computer 30 and the MPU 50, thereby constituting the RCP machine. The high performance computer 30 includes a CPU 31. The MPU 50 includes a PWM signal processing unit 51 generating a high resolution PWM signal and an A/D converter 52.

As illustrated in FIG. 3B, the high performance computer 30 includes the same constitutional elements such as a memory 32 or a PCI_I/F 33, as those of a typical PC architecture, in addition to the CPU 31. The bridge 40 is a DMA circuit provided with a DMAC (Direct Memory Access Controller) 41, a PCI_I/F 42, FIFOs 43 and 44, and a SRAM_I/F 45, and is formed with, for example, a FPGA or a PCI Target Interface Adapter (“APIC_21”). The MPU 50 includes an SRAM_I/F 45 in addition to the PWM signal processing unit 51 and the A/D converter 52, and although not illustrated, includes a calculation function and a memory required for functioning as the processor.

In the embodiment, a data transfer between the MPU 50 and the bridge 40 is performed using a DMA transfer between memories (a memory of MPU 50 and FIFOs 43 and 44) through the SRAM_I/F. Since the MPU 50 is operated according to any logic by a user, it is possible to operate the MPU 50 according to the switching period of the switching power supply 60 of the control target such that real time operability may be secured. A data transfer between the high performance computer 33 and the bridge 40 is performed using the DMA transfer through the PCI_I/F 33. The data transfer described above may be referred to as a DMA transfer performed through a bridge 40 between a memory 32 and the memory of the MPU 50.

A DMA access (data transfer) may send a large amount of data at a high speed, but is unable to transmit and receive a small amount of data at a high speed and in “a predetermined period (switching period).” In contrast, in a PIO access, since the CPU 31 performs access per a single word, a scheduling may be freely performed to transmit and receive the data. However, in a case where the CPU 31 performs, for example, other computation, a transmission and reception itself may not be performed. Further, a memory access latency is high and thus the transmission and reception of data may not be performed at a high speed. Here, two access schemes of the DMA access and the PIO access are combined to secure high speed operability utilizing characteristics of the access schemes.

The data transfer between the high performance computer 30 and the MPU 50 through the bridge is divided into a first data transfer and a second data transfer. The first data transfer corresponds to a transfer of the AD value from the MPU 50 to the high performance computer 30, and the second data transfer corresponds to a transfer of the compensation value data (PWM data) from the high performance computer 30 to the MPU 50.

In the first transfer (AD value transfer), the MPU 50 writes the AD value into a predetermined address area of a memory of the MPU 50 and outputs an interrupt signal to bridge 40 when the writing is finished. Accordingly, the DMAC 41 of the bridge 40 transfers the data (AD value) in the predetermined address area of the memory of the MPU 50 to the memory 32 through SRAM_I/Fs 45 and 53, the FIFO 43, and PCI_I/Fs 33 and 42. The high performance computer 30 monitors the transfer of the AD value to the memory 32 by polling and immediately starts a processing for the second data transfer when the AD value is transferred to the memory 32. The processing of monitoring the transfer of the AD value to the memory 32 by polling in the high performance computer 30 will be described below.

In the second transfer (e.g., compensation value transfer), the CPU 31 of the high performance computer 30 stores compensation value (PWM) data calculated based on the AD value received at the previous period in order to allow the compensation value to be immediately transferred using DMA. When it is confirmed by polling that the AD value is transferred, the CPU 31 immediately instructs the DMAC 41 of the bridge 40 to perform the DMA transfer for the compensation value (PWM) data. The bridge 40 transfers the compensation value (PWM) data written into the memory 32 to the FIFO 44 through the PCI_I/Fs 33 and 42, and also transfers the compensation value (PWM) data to the memory of the MPU 50 through the SRAM_I/Fs 45 and 53. The CPU 31 may perform a separate processing after instructing the bridge 40 to perform the DMA transfer for the compensation value (PWM) data.

For example, the CPU 31 separates (validates) a write area for the compensation value (PWM) data and the PCI_I/F 33 for use by the bridge 40 after the compensation value (PWM) data is written into the memory 32. In this case, for example, an address in which the compensation value (PWM) data is stored is predetermined in the memory 32. Accordingly, the CPU 31 does not need to be directly involved in the DMA transfer of the compensation value (PWM) data and becomes able to access an area other than the write area for the compensation value (PWM) data of the memory 30. The PCI_I/F 42, the SRAM_I/F 45 and the SRAM_I/F 53 are always open as the interfaces dedicated for the first transfer and the second transfer, and the compensation value of the memory 32 is transferred to the memory of the MPU 50 at a high speed through the DMA transfer. In this case, the first transfer and the second transfer are normally not overlapped with each other, but a bus arbitration is performed by the MPU 50 as needed, and such overlapping is handled as an error.

The MPU 50 generates an AD value and writes the AD value into the predetermined area of the memory, and notifies the bridge 40 of the completion of the writing through an interrupt signal such that the AD value is transferred using DMA. The PCI_I/F 42, SRAM_I/F 45, SRAM_I/F 53 and PCI_I/F 33 are open, and the AD value of the MPU 50 is transferred to the memory 32 of the high performance computer 30 using DMA. The address of an area to which the AD value is transferred is predetermined in the memory 32. The CPU 31, as described above, monitors the memory 32 by polling, and separates the area to which the AD value is transferred in the memory 32 from the PCI_I/F 33 when the AD value is transferred to the memory 32. The CPU 31 controls the state of the connection between the compensation value storing area and the AD value transfer area of the memory 32 and the PCI_I/F 33 using the PIO access, as described above.

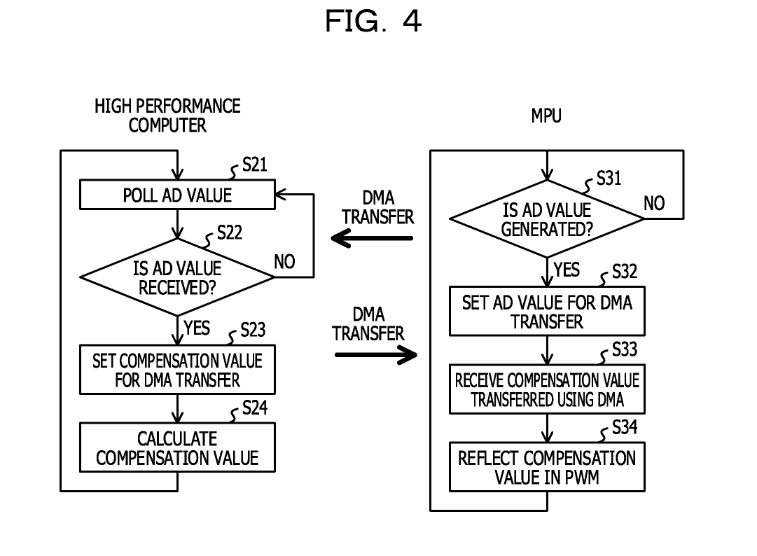

FIG. 4 is a flowchart illustrating the operations of the high performance computer 30 and the MPU 50 in the RCP system for power supply of the embodiment, specifically, the left part and right part of FIG. 4 illustrate the operations of the high performance computer 30 and the operations of the MPU 30, respectively.

First, descriptions will be made on the processing in the MPU 50. The following processings are performed for each switching period. At step S31, the MPU 50 manages the switching period and waits until a time reaches to a timing at which the AD value is generated from the detected signals (e.g., voltage signal, current signal) of each component of the switching power supply apparatus 60, and generates the AD value upon reaching the timing.

At step S32, the MPU 50 sets the AD value in the predetermined area of the memory to be transferred using DMA and notifies the bridge 40 of the completion of setting of the AD value through an interrupt signal. The bridge 40 immediately performs the DMA transfer for the AD value according to the interrupt signal and the AD value is transferred to the memory 32 of the high performance computer 30 using DMA. Since the bridge 40 performs only the DMA transfer, a period of time until the bridge 40 starts the DMA transfer processing for the AD value after receiving the interrupt signal is very short. Descriptions on the processing after the DMA transfer of the AD value will be made in conjunction with a processing in the high performance computer 30.

At step S33, the MPU 50 reads the compensation value (PWM) data already transferred to the memory by the DMA transfer.

At step S34, the MPU 50 generates a PWM signal from the compensation value (PWM) data and applies the PWM signal to a transistor of the switching power supply apparatus 60.

Next, descriptions will be made on the processing of the CPU 31 in the high performance computer 30. At step S21, the CPU 31 polls a counter bit added to the AD value transferred to the memory 32 using DMA by bridge 40.

At step S22, the CPU 31 determines whether the AD value is received using a value of the counter bit. When it is determined that the AD value is not received, the process returns to step S21, and the monitoring is repeated until the AD value is received. When it is determined that the AD value is received, the process proceeds to step S23.

At step S23, the CPU 31 stores the compensation value (PWM) data which has been calculated based on the AD value received at the previous period in the predetermined area of the memory 32 in order to be transferred using DMA, and notifies the bridge 40 of the completion of setting of the compensation value (PWM) data through an interrupt signal. Also, in this case, the bridge 40 immediately performs the DMA transfer for the compensation value (PWM) data such that the compensation value (PWM) data is transferred to the memory of the MPU 50 using DMA.

At step S24, the CPU 31 calculates the compensation value (PWM) data based on the AD value received at step S22 and stores the compensation value (PWM) data in the predetermined area of the memory 32, and the process returns to S21.

The high resolution control may be realized by combining the built-in type MPU with the high performance computer, but it is difficult to perform an accurate update of period on the power supply apparatus having a switching period in the order of μs (e.g., a period of 5 μs at a switching frequency of 200 kHz). Even when the CPU 31 of the high performance computer performs a DMA communication without being involved in a communication, since the CPU 31 involves in an interrupt generated at the timing of the completion of data transmission and reception and performs a processing such as saving values of a plurality of registers, an access time is not stable. In the PIO access in which the CPU 31 directly performs transmission and reception of data for the memory 32, a control period may not be set faster and may not make it in time for the switching period. Further, since the CPU 31 involves in the transmission and reception of data, a deviation between data transmission timing and data reception timing occurs due to a state of the CPU 31 occupying the registers, and the transmission timing of the compensation value to the MPU 50 and set timing of the PWM data by the MPU 50 vary.

In contrast, in the RCP system for power supply of the embodiment, as described above, the built-in type MPU and the bridge are combined with the high performance computer, and the high resolution control within the switching period is realized through the DMA transfer by the bridge and the polling of the high performance computer. The MPU 50 activates the DMA transfer which does not occupy resources of the CPU 31 in matching with the switching period of the power supply, and transfers the AD value to the memory 32 of the high performance computer 30. The CPU 31 sets the result of the completion of computation performed at the previous period in an area of the memory dedicated for the DMA transfer and transfers the result to the MPU 50, upon detecting the completion of transfer not by interruption but by polling. The CPU 31 also calculates the compensation value (PWM) data based on another transferred AD value.

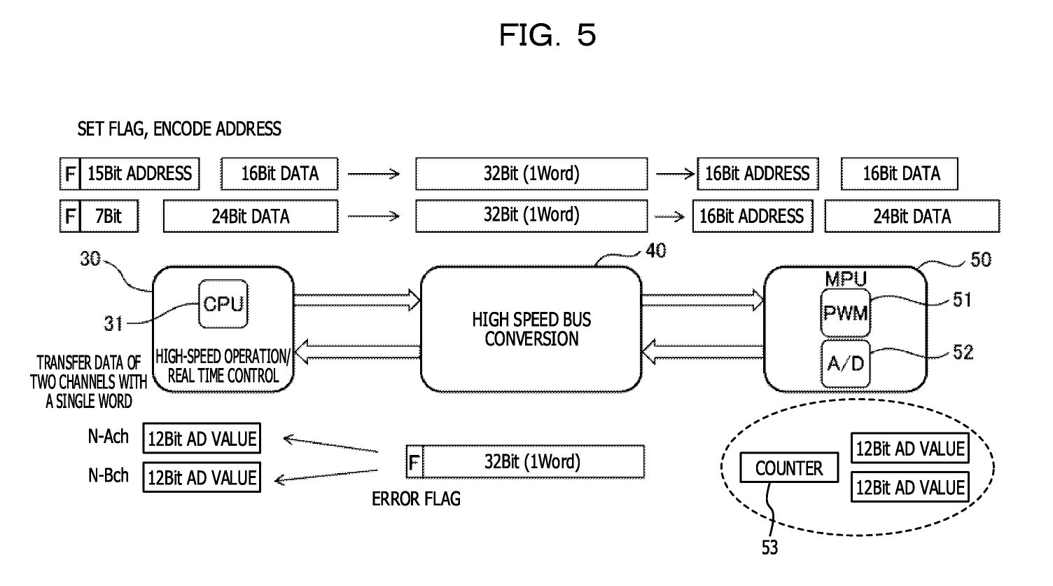

FIG. 5 is a diagram illustrating data transferred using DMA in the RCP system for power supply of the embodiment. In the RCP system for power supply of the embodiment, data consisting of many bits are transferred in order to perform a higher resolution control, but data may be transferred at different data lengths to reduce a bus occupying time according to the fixation of data length. First of all, descriptions will be made on data structures for the high performance computer 30 and the MPU 50 that serve as matters for the DMA.

The MPU 50 is a built-in type MPU, and may access a 16-bit (or 32-bit) address space and handle 24-bit (32-bit) data. However, only a small portion of the memory area is used by the MPU 50 for the control of the switching power supply apparatus 60. Further, a control is performed using 16-bit compensation value (PWM) data at the time of activation and 24-bit compensation value (PWM) data is used for an accurate control after having been activated. Accordingly, the CPU 31 of the high performance computer 30 generates the 16-bit compensation value (PWM) data using a 15-bit address at the time of activation and sets a foremost single bit flag to a value (e.g., “0”) which indicates a 16-bit data. Further, the CPU 31 of the high performance computer 30 generates the 24-bit compensation value (PWM) data using a 7-bit address at the time of a typical operation after having been activated and sets the foremost single bit flag to a value (e.g., “1”) which indicates a 24-bit data. The CPU 31 writes the two types of 32-bit data in a predetermined area of the memory 32 and instructs the bridge 40 to perform the DMA transfer. The bridge 40 transfers these 32-bit data to the predetermined area of the memory of the MPU 50. In FIG. 5, although the 15-bit and 7-bit addresses are illustrated to be transferred to areas represented by the 16-bit address, but, as described above, since the address space of the MPU 50 is 16-bit address space, and an area to be used is limited, and thus unnecessary bits are filled with “Os.” The MPU 50 handles the data of an address to which data having the flag of “0” is transferred as the 16-bit data, and the data of an address to which data having the flag of “1” is transferred as the 24-bit data. Up to now, the DMA transfer of the compensation value (PWM) data from the high performance computer 30 to the MPU 50 has been described.

The AD value generated by the MPU 50 is 12-bit data and two AD values are included in 32-bit data to be transferred to the high performance computer 30 using DMA. Among the remaining eight bits of the 32-bit data, one bit is an error flag and a count value counted down for each switching period is added to the seven bits. As illustrated in FIG. 5, the MPU 50 includes a counter 53 to which the maximum value is set at the time of initial setting, the maximum value is counted down for each switching period after the initial setting, and the counted down count value is added to the data to be transferred. When a plurality of AD values are generated, the MPU 50 sets the data to be transferred using DMA in the predetermined area of the memory in the data format described above. Accordingly, the bridge 40 transfers the data to the predetermined area of the memory 31 of the high performance computer 30 using DMA. The CPU 31 has stored the count value obtained at the previous period, checks the count value of the 32-bit data transferred using DMA by polling, and detects that a new AD value is transferred when the count value is reduced by one (1) as compared to the stored count value. The CPU 31 checks an error flag, and extracts two 12-bit AD values among the 32-bit data when there is no error.

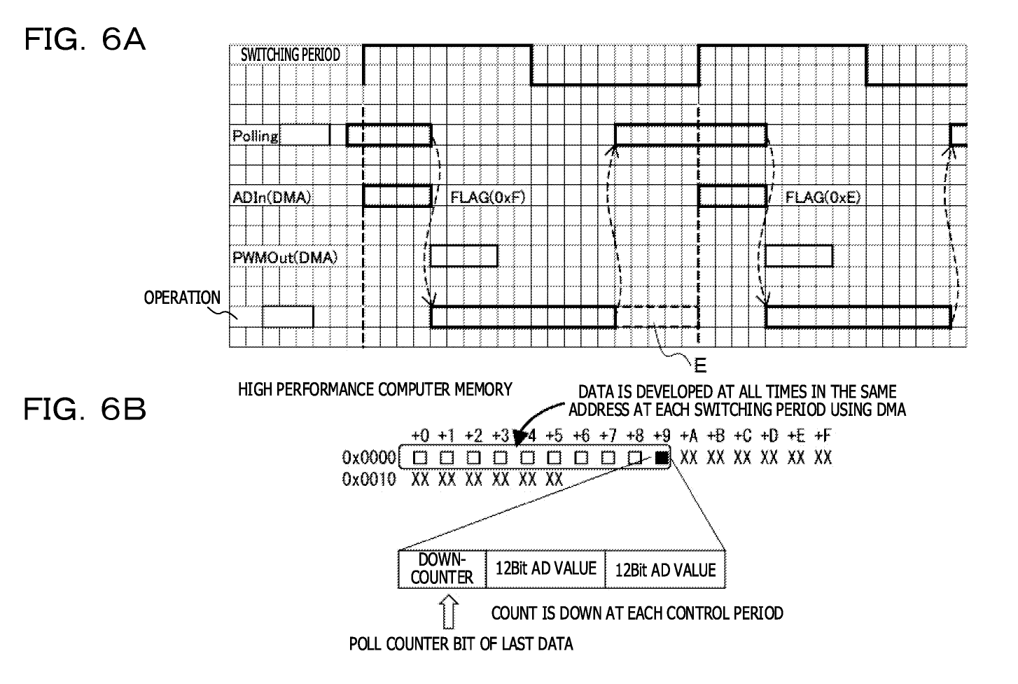

FIG. 6A and FIG. 6B are diagrams for explaining a transfer of AD value by polling of a counter which polls a count value. Specifically, FIG. 6A and FIG. 6B illustrate a time chart and a data configuration in data to be transferred, respectively. Here, descriptions will be made on an assumption that the MPU 50 performs the AD conversion on the detected signal in synchronization with a rise time of signal which indicates the switching period and generates the AD value.

As illustrated in FIG. 6A, the CPU 31 polls before the rise of the switching period signal. The MPU 50 generates the AD value in synchronization with the rise of the switching period signal and instructs the bridge 40 to perform the DMA transfer, such that the AD value is transferred using DMA (ADIn(DMA)). As described above, an error bit and a count value are added to the AD value, and FLAG (0xF) is added to the AD value in FIG. 6.

The CPU 31 confirms the FLAG (0xF) containing the count value by polling and detects that the AD value is transferred. The CPU 31 instructs the bridge 40 to perform the DMA transfer of the compensation value (PWM) data calculated based on the AD value transferred at the previous switching period and stored in the predetermined area of the memory 32, such that the compensation value (PWM) data is transferred using DMA according to the instruction (PWMOut (DMA)). Further, the CPU 31 starts calculating the compensation value (PWM) data based on the transferred AD value and writes the calculated compensation value (PWM) data into the predetermined area of the memory 32. Also, the CPU 31 starts monitoring again whether the AD value is transferred, by polling. A flag containing a count value to be checked at next by the CPU 31 is decreased from the FLAG (0xE) by one (1).

As illustrated in FIG. 6B, an area to which the AD value is transferred is predetermined in the memory 32 and data of the AD value is developed (transferred) at all times in the same address at each switching period. In FIG. 6B, an address space ranging from an address 0x00000(+0) to an address 0x00009(+9) corresponds to the transfer area, and the CPU 31 polls a bit value of the down converter stored in address 0x00009(+9) to monitor the data transfer.

As illustrated in FIG. 6A, since the transfer of the compensation value (PWM) data may be performed by simply instructing the bridge 40 to perform the DMA transfer right after the transfer of AD value is detected, the CPU 31 does not directly involve in the transfer of the compensation value (PWM) data. The CPU 31 performs polling after calculating the compensation value (PWM) data and performs writing the PWM into the predetermined area of the memory 32, and thus the polling may be started until the next switching period is started. Therefore, the CPU 31 may extend a calculation period for the compensation value (PWM) data to a period of time indicated by “E” in FIG. 6A.

In the RCP system for power supply of the embodiment, since a case where a processing does not follow a processing sequence in the bridge 40 and the MPU 50 for some reason indicates that a fault has occurred, the high performance computer 30 may be notified of the occurrence of the case. Accordingly, the bridge 40 and the MPU 50 erect an error flag in an error bit located at the foremost of the 32-bit transfer data containing the AD value illustrated in FIG. 5.

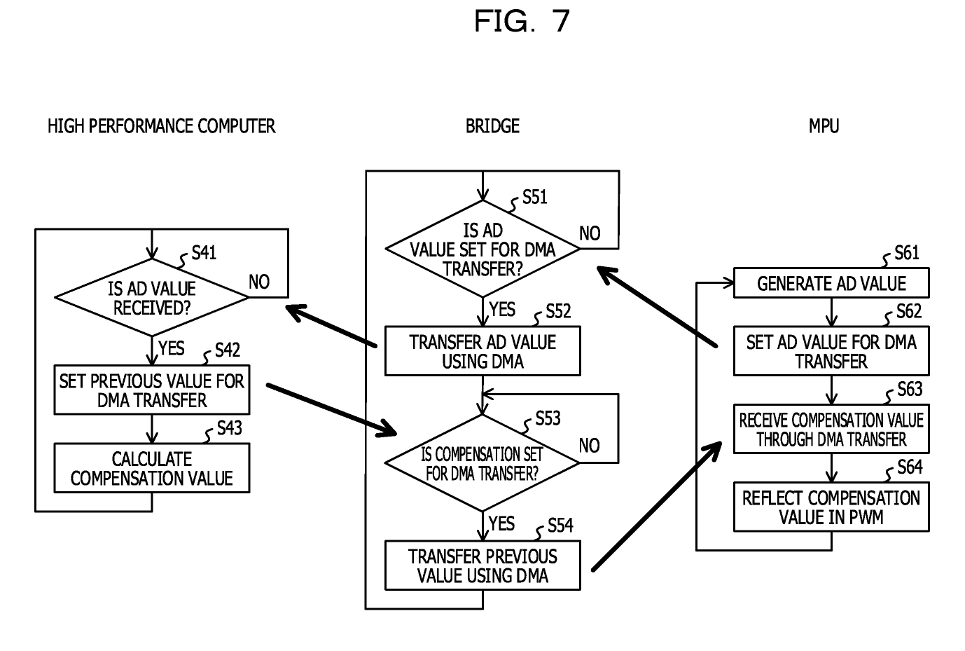

FIG. 7 is a flowchart illustrating the operations of the high performance computer 30, the bridge 40, and the MPU 50 in the RCP system for power supply of the embodiment. Specifically, the left part, the central part, and the right part of FIG. 7 illustrate the operations of the high performance computer 30, the bridge 40, and the MPU 50, respectively. The operations of the high performance computer 30 and the MPU 50 are substantially the same as those of FIG. 4.

The MPU 50 performs generating (converting) the AD value at S61 and setting for the DMA transfer of the AD value at S62 at each switching period. The bridge 40 waits for the instruction to perform the DMA transfer of the AD value at S51, and performs the DMA transfer of the AD value at S52 when the instruction to perform the DMA transfer of the AD value is issued. The high performance computer 30 monitors by polling whether the AD value is received at S41 and performs the setting for the DMA transfer of the compensation value (PWM) data, which is calculated based on the AD value previously obtained, at S42 when the AD value is received. The bridge 40 waits for the instruction to perform the DMA transfer of the compensation value (PWM) data at S53 and performs the DMA transfer of the compensation value (PWM) data at S54 when the instruction to perform the DMA transfer of the AD value is issued. When the compensation value (PWM) data is received at S63, the MPU 50 generates a PWM signal based on the compensation value (PWM) data and reflects the PWM signal in the control at S64.

When the processing sequence described above is not observed, the bridge 40 and the MPU 50 determine that an error has occurred and erect an error flag in an error bit located at the foremost of the 32-bit transfer data. For example, in a case where the instruction to perform the DMA transfer of the AD value is received from the MPU 50 before the DMA transfer of the compensation value (PWM) data performed at S54 is completed, the bridge 40 determines that an error has occurred and erects an error flag. Similarly, in a case where the instruction to perform the DMA transfer of the compensation value (PWM) data is received from the high performance computer 30 before the DMA transfer of the AD value data at S52 is completed, the bridge 40 determines that an error has occurred and erects an error flag. In a case where the compensation value (PWM) data is received from the bridge 40 through the DMA transfer before the instruction to perform the DMA transfer of the AD value at S62 is issued, the MPU 50 determines that an error has occurred and erects an error flag. Further, in a case where an AD value acquisition (conversion) timing arrives before reflecting the compensation value (PWM) data in the control of the switching power supply apparatus 60 at S64, the MPU 50 determines that an error has occurred and erects an error flag. When data containing the AD value in which the error flag is erected is received, the high performance computer 30 stops simulation and notifies an error occurrence.

The descriptions in the previous paragraph correspond to a case where an error occurrence is determined in the bridge 40 and the MPU 50, but an error occurrence may be determined also in the high performance computer 30 in a case where the processing sequence is not observed.

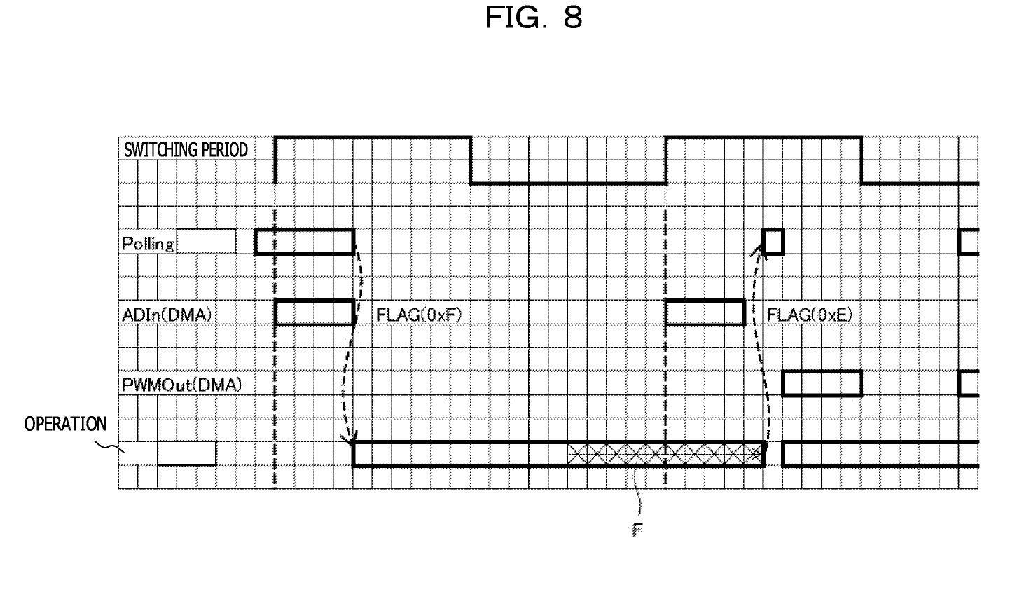

FIG. 8 is a time chart illustrating a detection of an overrun in which the calculation of a compensation value (PWM) data is not finished until the transfer of the AD value at a next switching period is completed, in the high performance computer 30.

FIG. 8 is similar to FIG. 6A, but is different in that a period of time during which the CPU 31 calculates the compensation value (PWM) data and writes the PWM data into the predetermined area of the memory 32 is extended to a time represented by “F.” In this case, a situation occurs where the polling is started at a timing after the AD value is transferred at the next switching period and an AD value to be transferred at the next switching period but already transferred is unable to be recognized, and it is needed to determine the situation as an error.

It is required to finish calculating the compensation value (PWM) data and writing the compensation value (PWM) data into the predetermined area of the memory 32 by the CPU 31 before the transfer of the AD value is completed. Accordingly, in a case where the count value is a value already counted down when the count value of the data of address to which AD value is transferred is checked initially at the time of starting of the polling, the CPU 31 determines that an overrun has occurred.

As described above, the RCP system for power supply of the embodiment has been described, but the transfer of the AD value to the memory 32 of the high performance computer 30 will be described by comparing a case where the transfer of the AD value is detected by polling as in the embodiment with a case where the AD value is transferred from the bridge 40 to the high performance computer 30 by an interruption processing.

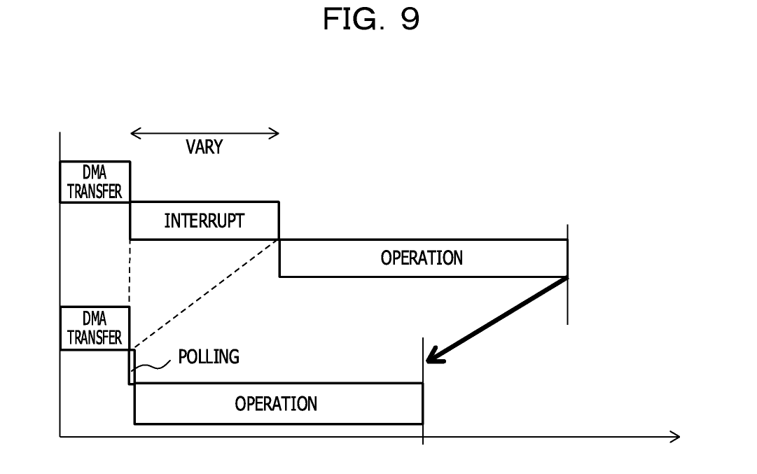

FIG. 9 is a diagram illustrating a comparison of the two cases, and the upper part of FIG. 9 illustrates the case of performing through the interruption processing and the lower part of FIG. 9 illustrates the case of detecting by polling.

In the case of performing through the interruption processing, an interrupt signal is output from the bridge 40 to the CPU 31 after the AD value is transferred using DMA. Accordingly, the CPU 31 saves, for example, a register value being processed and then calculates the compensation value (PWM) data. Since a processing amount for the saving processing is different depending on an occupation state of the CPU 31, a time required for the interrupt processing varies and is not constant.

In contrast, since the case of detecting by polling does not require, for example, a saving processing, a calculation processing is started after a constant short period of time is elapsed after the AD value is transferred using DMA.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An RCP (Rapid Control Prototyping) system for controlling a power supply apparatus, the RCP system comprising:
a computer;
an MPU; and
a bridge configured to connect the computer and the MPU and transfer data between the computer and the MPU using DMA,
wherein the MPU is configured to generate an AD value from a signal of the power supply apparatus according to a switching period of the power supply apparatus, instruct to transfer the generated AD value to the computer using DMA via the bridge, and control the power supply apparatus according to a compensation value transferred using DMA via the bridge, and
the computer is configured to instruct to transfer the compensation value calculated based on the AD value transferred through the last DMA to the MPU using DMA via the bridge and calculate the compensation value based on the AD value newly transferred using DMA, after detecting by polling that the AD value has been transferred from the MPU via the bridge using DMA.

2. The RCP system according to claim 1, wherein the MPU is configured to include a counter changing a count value at each switching period, and add the count value of the counter to the AD value when transferring the AD value to the computer, and
the computer is configured to monitor the count value data to be stored in an address to which the AD value is transferred using DMA so as to detect that the AD value has been transferred using DMA.

3. The RCP system according to claim 1, wherein the computer is configured to determine an overrun by detecting a delay in a start of polling from the count value at the time when the polling starts.

4. The RCP system according to claim 1, wherein the MPU and the bridge are configured to detect an occurrence of an error from a processing sequence and erect an error flag in an error bit added to the AD value to be transferred to the computer when the error has occurred.
